(19) United States
(12) Patent Application Publication
(10) Pub. No.: US 2013/0030144 A1
(43) Pub. Date: Jan. 31, 2013

(54) STAR POLYMERS HAVING CONTROLLED TACTICITY AND METHODS OF MAKING SAME

(71) Applicant: Michael P. Shaver, Stratford (CA)

(72) Inventor: Michael P. Shaver, Stratford (CA)

(21) Appl. No.: 13/520,919

(22) PCT Filed: Jan. 6, 2011
(86) PCT No.: PCT/CA2011/000005

§ 371 Date: Jul. 6, 2012

Related U.S. Application Data
(60) Provisional application No. 61/293,269, filed on Jan. 8, 2010.

(51) Int. Cl. C08G 63/82; C08G 63/00

(52) U.S. Cl. 528/282

(57) ABSTRACT

Disclosed is a method for synthesizing star polymers having controlled tacticity. The method comprises reacting a lactone-based monomer having at least one stereocentre and a poly-functional initiator in the presence of at least one catalyst. In particular embodiments, the lactone-based monomer is L-lactide or DL-lactide, the poly-functional initiator is dipentaerythritol, and the at least one catalyst is an aluminum-salen catalyst (^{tBu}[O,N,N,O] AlMe) or an aluminum-salan catalyst (^{Cl}[O,N,N,O] AlMe). Star polymers comprising at least two arms and having heterotacticity bias, isotacticity bias, or stereoblocks of different tacticity bias are produced. Such star polymers are useful, for example, in controlled delivery of bioactive molecules

### CROSS-REFERENCE TO RELATED APPLICATIONS

This application claims priority to U.S. Provisional Application 61/293,269, filed Jan. 8, 2010 which is incorporated herein by reference.

### FIELD OF THE INVENTION

Generally, the present application relates to a method for synthesizing star polymers. More specifically, the application relates to a method for synthesizing star polymers having controlled tacticity and includes polymers made by such methods.

### BACKGROUND OF THE INVENTION

Star polymers contain multiple polymeric arms radiating from a central core and are of great interest due to their structure. Star polymers possess different properties than linear polymer chains because of their extensive branching from a central point. For instance, this feature can make the polymers behave more like nanoparticles and give them unique properties.

Potential applications of star polymers include lubricant additives, thermoplastics, high-melting adhesives, high-performance coatings, polymers with high shear stability. Another possible application of star polymers is in controlled release of bioactive molecules. For example, the strands can intertwine in different ways allowing for the encapsulation of guest molecules, such as drugs.

In comparison to conventional dosage systems, controlled drug delivery technologies can offer various advantages, such as: increased therapeutic activity compared to the intensity of side effects, and reduced number of administrations per treatment. It would be desirable to synthesize star polymers of controlled degradation profile, which could be embedded with a bioactive molecule to provide a controlled release drug delivery system. However, in the prior art, control over the degradation profile of star polymers has not been achieved.

Various linear polymer chains have previously been explored for use in controlled-release drug delivery systems. Polymers including poly(2-hydroxy ethyl methacrylate), poly(N-vinyl pyrrolidone), poly(methyl methacrylate), poly(vinyl alcohol), poly(acrylic acid), polyacrylamide, poly(ethylene-co-vinyl acetate), poly(ethylene glycol) and poly(methacrylic acid) have been used. However, none of these polymers chemically degrade, but instead possess physical properties that made them potential drug delivery candidates.

Other polymers, designed primarily for medical applications, have been developed, with many of these materials designed to degrade within the body. Such polymers include poly(lactic acid) (PLA), polyglycolides, poly(lactic acid-co-glycolic acid), polyanhydrides and poly(ortho-esters). PLA was used as an absorbable suture material before being used in drug delivery applications. These degradable polymers are broken down into biologically assimilable molecules that are metabolized and removed from the body via standard metabolic routes. With linear polymer chains, degradation rate is typically controlled by the length of polymer chain, the monomer used (rac-lactide, meso-lactide or pure D- or L-lactide) and the end group of the polymer chain.

Few studies have explored the possibility of using star polymers to control the delivery of bioactive molecules. Such studies have met with limited success since the star polymers are difficult and expensive to make. Moreover, there is often poor control over their properties, and the star polymers exhibit burst defects, issues with batch-to-batch reproducibility, and inconsistencies with in-vitro vs in-vivo behavior.

One example of a polymeric chain that can be used in the synthesis of a star polymer is poly-lactic acid or polylactide (PLA). PLA is biodegradable, and stereocomplex blends of poly-D-lactide (PDLA) and poly-L-lactide (PLLA) have a wide range of biomedical applications, such as: sutures, stents, dialysis media and drug delivery devices.

If a bioactive molecule is embedded within a PLA matrix, the polyester bonds of the PLA can degrade to release the bioactive molecule over time. The degradation process can be impacted by the structure of the PLA, by the variation of the end group composition (where end-groups can delay the initiation of the degradation process) and by the polymer macrostructure. In the case of star polymers having a central core surrounded by radiating polymeric chains, the multi-functional central cores can affect the polymer macrostructure, and hence physical properties and degradation rates.

PLA, a renewable, biodegradable, bioassimilable polymer, can be made through the polymerization of lactide. Lactide is a cyclic dimer of lactic acid having two stereocenters. The two stereocenters result in three different stereoisomers of lactide: L,L-lactide (also known as L-lactide), D,D-lactide (also known as D-lactide) and D,L-lactide (also known as meso-lactide). A mixture of equal amounts of D- and L-lactide is known as rac-lactide. PLA of high molecular weight can be produced from the ring-opening polymerization of lactide monomer using a catalyst.

Due to the chiral nature of L-lactide and D-lactide, PLA can be synthesized having a range of chemical structures with different stereocomplexity. The relative stereochemistry of two adjacent chiral centres within a macromolecule is a measure of the macromolecule's tacticity. “Tacticity bias” (or simply “bias”) is a percentage measure of the uniformity of the stereochemistry the macromolecule. In an isotactic polymer, the stereochemistry of all the isomers are the same and the polymer could be described as having 100% isotacticity bias. In a heterotactic polymer of PLA, the L- and D-monomeric units alternate along the polymer chain (e.g. -DLDLDL-) and the polymer could be described as having 100% heterotacticity bias. An isotactic polymer would have 0% heterotacticity bias. A polymer having an isotactic block and another heterotactic block of the same length could be described as having 50% isotacticity bias and 50% heterotacticity bias. A polymer having a fully random arrangement of stereocentres is an atactic polymer and could be described as having “0% isotacticity bias and 0% heterotacticity bias” or “100% atacticity bias”.

For example: (a) PLLA is the product resulting from polymerization of only L,L-lactide and has 100% isotacticity bias; (b) PDLA is the product resulting from polymerization of only D,D-lactide and has 100% isotacticity bias; and (c) polymerization of a racemic mixture of L- and D-lactides using a non-stereospecific catalyst can lead to the synthesis of poly-DL-lactide (PDLLA) having a random arrangement of stereocenters with 100% atacticity bias.

Unfortunately, known methods of controlling the stereocomplexity of linear polymers do not translate to the manufacture of star polymers. It is therefore desirable to have a method of synthesizing star polymers having controlled stereocomplexity as this can provide a specific degradation profile useful in various applications, such as controlled release of bioactive molecules.

### SUMMARY OF THE INVENTION

In one aspect, the present application provides a star polymer comprising a poly-functional core linked to at least two arms, the at least two arms comprising a polymerized monomer and the monomer having at least one stereocentre, where the star polymer has a tacticity bias which is: (a) a heterotacticity bias between about 1% and 100%; (b) an isotacticity bias between about 1% and 100%; or (c) a heterotacticity bias between about 1% and 99% and an isotacticity bias between about 1% and 99%.The polymerized monomer can be a stereoblock co-polymer comprising heterotactic and isotactic stereoblocks, the star polymer having a heterotacticity bias between 1% and 99% and has an isotacticity bias between 1% and 99%. The polymerized monomer can also comprise atactic stereoblocks. The star polymer can have a heterotacticity bias between about 1% and 90%. The poly-functional core can be linked to 6 arms.

In another aspect of the present application, a method is provided for synthesizing a star polymer. The method comprises the steps of reacting a lactone-based monomer and a poly-functional initiator in the presence of at least one catalyst to produce the star polymer, where the reaction is a low solvent reaction, and where the monomer does not comprise —NH— or —OH functional groups or double bonds or triple bonds. In embodiments where the monomer has at least one stereocentre, the synthesized star polymer can have (a) a heterotacticity bias between 1% and 100%, (b) an isotacticity bias between 1% and 100%, or (c) a heterotacticity bias between 1% and 99% and an isotacticity bias between 1% and 99%.

The synthesized star polymer can comprise at least two arms comprising a polymerized monomer, the polymerized monomer being a stereoblock co-polymer comprising heterotactic and isotactic stereoblocks, and the star polymer having a heterotacticity bias between 1% and 99% and has an isotacticity bias between 1% and 99%. In particular embodiments, the synthesized star polymer can have (a) a heterotacticity bias between 1% and 90%, or (b) a heterotacticity bias between 1% and 90% and an isotacticity bias between 1% and 99%. The synthesized star polymer can have a heterotacticity bias between 1% and 90% and an isotacticity bias between 1% and 99%.

In particular embodiments of the method, the lactone-based monomer can be Iactide. The poly-functional initiator can be dipentaerythritol. The at least one catalyst can be a Lewis acid-based catalyst comprising Al, Zn, Mg, Ca, Fe, Ga, or In, the catalyst having an alkyl functionality or having an alkyl functionality created in situ, and the catalyst being thermally stable at reaction conditions.

The at least one catalyst can be selected from the group consisting of:

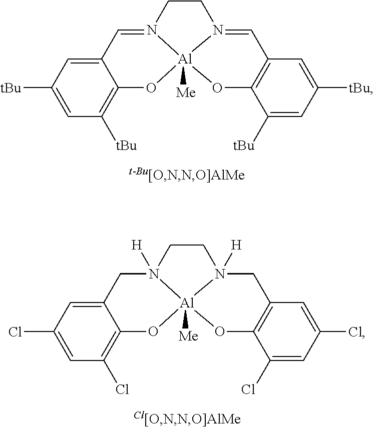

tin(II)octanoate, and any combination thereof.

Other aspects and features of the present invention will become apparent to those ordinarily skilled in the art upon review of the following description of specific embodiments of the invention in conjunction with the accompanying figures.

### DESCRIPTION OF THE FIGURES

Other aspects and features of the present application will become apparent to those ordinarily skilled in the art upon review of the following description of specific embodiments in conjunction with the accompanying figures.

Embodiments will now be described, by way of example only, with reference to the attached Figures, wherein:

FIG. 1 is a graph illustrating TGA overlay of star-shaped PLAs possessing various tacticities;

FIG. 2 is a graph illustrating DSC overlay of Tg observed for star-shaped PLAs with various tacticity biases;

FIG. 3 is a graph illustrating DSC overlay for star-shaped PLAs with an isotactic bias;

FIG. 4 is a graph illustrating p-XRD analysis of star-shaped PLAs.

### DETAILED DESCRIPTION

Generally, the present invention provides a method for synthesizing star polymers having controlled stereocomplexity.

Star polymers can be synthesized using a variety of cores. According to one aspect of the present application, dipentaerythritol (DPE) can be used as the core to create a six-armed star polymer. To make a four-armed star polymer, pentaerythritol can be used as the core. Other cores can also be used. The other cores can have different numbers of polymerization sites, resulting in star polymers with different numbers of polymer arms.

The polymer arms can, for example, comprise poly-lactide polymers. However, the physical properties of a star polymer can be controlled by changing the side chains in the polymer arms. While lactide is a cyclic di-ester of 2-hydroxypropanoic acid, other monomers can alternatively be used in the polymerization reaction to form star polymers with different physical properties. Contemplated monomers for the present application include at least one stereocentre and a cyclic lactone but do not include monomers containing double bonds or triple bonds, or —OH or —NH—. Polymer arms with pre-determined tacticity bias can be formed from the polymerization of monomers having lactone rings containing one or more ester functional groups (e.g. lactide which has two lactone groups) and one or more stereocentres (e.g. lactide, which has two stereocentres). Examples of lactide variants which can be used in the synthesis of star polymers according to the present application are described in PCT/US00/33869 (BAKER, G. and SMITH, M.), incorporated herein by reference.

In particular embodiments, the monomers are cyclic di-esters and changing the side chain of the monomer (such as through the use of the cyclic di-ester of 2-hydroxybutanoic acid, or 2-hydroxy-2-chloropropanoic acid) can change the physical properties of the resulting star polymer.

In particular embodiments, the polymer arms can be synthesized using racemic mixtures of monomers.

In particular embodiments, the polymer arms can be copolymers. For example, the polymer arms can be copolymers of PLA, such as PLA and polyglycolide or PLA and ethylene glycol, even if polyglycolide and ethylene glycol do not themselves have any stereocentres. Such polymer arms can be synthesized using a mixture of lactide and glycolide monomers, or lactide and ethylene oxide monomers, or both.

In particular embodiments, synthesis of star polymers are undertaken in low solvent polymerization reactions. In the context of the present application, a “solvent” would be understood by a person of skill in the art to be an unreactive liquid that dissolves or dilutes other substances. A “low solvent” reaction, as used herein, is a reaction that includes less than 1 volume of solvent per 1 volume of liquid monomer. Typically, polymer synthesis reactions take place in much higher solvent volumes.

In other embodiments, the synthesis of star polymers are undertaken in substantially solvent-free polymerization reactions. “Substantially solvent-free”, as used herein, is a reaction that includes less than 10% solvent volume/volume, with the remainder of the reaction species being capable of reacting under the reaction conditions, even if not all of the reactants are consumed in the reaction. In some embodiments, a “substantially solvent-free” reaction is a reaction that includes less than 8% solvent, or less than 5% solvent, or less than 2% solvent, or less than 1% solvent, or less than 0.5% solvent, or less than 0.1% solvent, or 0% solvent.

In particular embodiments of the contemplated polymerization reactions, at least one component is a liquid under reaction conditions and the reaction is performed “neat”, i.e. without solvent. For example, in polymerization reactions using lactide as the monomer, dipentaerythritol as the core and Al-salen as the catalyst, the lactide monomer is liquid under reaction conditions and serves to dissolve the remaining reaction components.

Known linear polymerization catalysts can be used for the synthesis of the contemplated star polymers. The catalysts must be Lewis acids, must have an alkyl functionality or have an alkyl functionality created in situ, and must have an appropriate ligand to control the incoming monomer units. Various Zn, Mg, Ca, Fe, Ga, and In catalysts known in the art show isospecificity in polymerization of linear PLA polymers.

The selected catalyst or combination of catalysts should be thermally stable at reactions conditions.

Additionally, the Lewis acid catalyst/ligand combination must be monometallic and thermally stable at reaction temperatures. In reactions performed using “neat” solvent conditions (i.e. 0% solvent) and lactide as the monomer, the Lewis acid catalyst/ligand combination should be stable at least at the melting temperature for lactide (97° C.). In particular embodiments, the Lewis acid catalyst/ligand combination would be stable up to the decomposition temperature of lactide and/or the resulting star polymer. A skilled person will be able to select an appropriately thermally stable catalyst for the particular reaction. In particular embodiments, the Lewis acid catalyst/ligand combination would be stable up to 250° C. In particular embodiments, catalysts useful for the synthesis of linear PLA can be used for the synthesis of star polymers. Examples of such catalysts are described in Hormnirun, P; Marshall, E; Gibson, V; White, A; Williams, J. J. Am. Chem. Soc. 2004, 126, 2688 and Hormnirun, P; Marshall, E; Gibson, V; Pugh, R; White, A. PNAS. 2006, 103, 15343, which references are incorporated herein by reference.

In particular embodiments, the polymerization synthesis can be undertaken using aluminum, having a salen ligand, to catalyze the reaction. In other embodiments, aluminum catalysts complexed with a salan ligand can be used. See, for example, Table 1. The electron-withdrawing/donating character, as well as the steric bulkiness, of the aluminum-salen and aluminum-salan catalysts can play a role in controlling the stereocomplexity of the star polymer. Examples of general salen and salan ligands are shown below.

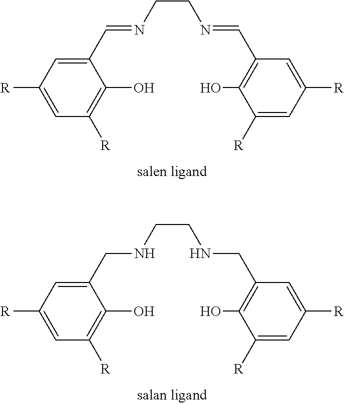

In an embodiment of a method contemplated by the present application, a DPE core can be used to make a star polymer having 100% isotacticity bias using a mixture of D- and L-lactide. In such an embodiment, the resulting star polymer can be an isotactic stereoblock (D, L) PLLA/PDLA star polymer. An isotactic stereoblock polymer is a polymer having stereoblocks of L-lactide and D-lactide alternating throughout the macromolecule. Such a star polymer can be synthesized using an aluminum-salen catalyst (^{tBu}[O,N,N,O]AlMe, shown below) and a mixture of D- and L-lactide.

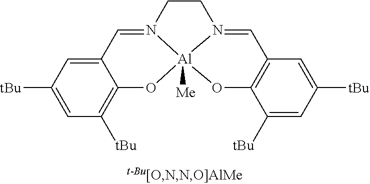

In a further embodiment of a method contemplated by the present application, the DPE core can be used to make a star polymer having 100% heterotacticity bias using a mixture of D- and L-lactide. In such an embodiment, the resulting star polymer is a heterotactic PLA star polymer (i.e. a star polymer with alternating D- and L-lactide monomers). Such a star polymer can be synthesized using an aluminum-salan catalyst (^{Cl}[O,N,N,O]AlMe, shown below) and a mixture of D- and L-lactide.

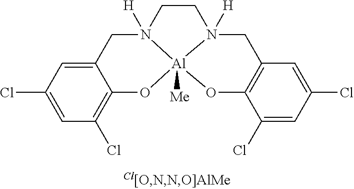

In an embodiment according to the present application, a star polymer can be synthesized having a poly-functional core and polymer arms which have 100% heterotacticity bias or 100% isotacticity bias.

In another embodiment according to the present application, a star polymer can be synthesized (for example using aluminum-salan as the catalyst and a mixture of D- and L-lactide as the monomer) having a poly-functional core, such as DPE, and polymer arms which have a heterotacticity bias greater than 1% and less than 99%. In particular embodiments, the star polymer can have a heterotacticity bias greater than about 5%, 10%, 20%, 30%, 40%, 50%, 60%, 70%, 80% or 90%, and less than 99%.

In another embodiment, the DPE core can be used to make a star polymer having a mixture of heterotactic and isotactic blocks. In such an embodiment, the star polymer can be synthesized using a mixture of aluminum-salan and aluminum-salen as catalysts, and a mixture of D- and L-lactide as the monomers. Varying the relative amounts of the aluminum-salan and aluminum-salen catalysts allows for the star polymer to be made with defined relative amounts of heterotactic and isotactic blocks. For example, the resulting star polymer can be 25% heterotactic and 75% isotactic. Addition of a non-isospecific catalyst (for example, tin(II)octanoate) could result in a star polymer having atactic portions. Such a star polymer could, for example, be 60% heterotactic, 20% isotactic and 20% atactic.

In various embodiments, star polymers formed using mixtures of catalysts can be greater than 1% heterotactic, 1% isotactic and less than 98% atactic. In particular embodiments, star polymers formed using mixtures of catalysts can be greater than about 5%, 10%, 20%, 30%, 40%, 50%, 60%, 70% 80% or 90% heterotactic; greater than about 5%, 10%, 20%, 30%, 40%, 50%, 60%, 70% 80% or 90% isotactic; and less than 5%, 10%, 20%, 30%, 40%, 50%, 60%, 70% 80% or about 90% atactic.

The polymeric properties of PLA-based DPE star polymers are shown in Table 1, with low polydispersities and molecular weights matching the monomer:initiator ratio used. The stereocomplexity of such PLA polymer chains of the star polymers is similar to the stereocomplexity for the corresponding linear PLA chains, see Table 2.

TABLE 1
Polymeric properties of PLA-based DPE star polymers.

| | | | | Mn | | | % | ^{c}D |
|---|---|---|---|---|---|---|---|---|
| # | Catalyst | Lactide | Term. group | Calc | Mn | PDI | Conv. | arm |
| 1 | tin(II)octanoate | rac- | MeOH | 9464 | 8873 | 1.14 | 94 | 1.89 |
| | | lactide | | | | | | |
| 2 | tin(II)octanoate | rac- | BnOH | 9833 | 9058 | 1.18 | 92 | 2.14 |
| | | lactide | | | | | | |
| 3 | tin(II)octanoate | L-lactide | MeOH | 8781 | 8771 | 1.18 | 99 | 2.14 |
| 4 | tin(II)octanoate | L-lactide | BnOH | 8781 | 8691 | 1.08 | 99 | 1.51 |
| 5 | Al(salan) | rac- | MeOH | 8923 | 8755 | 1.26 | 95 | 2.65 |
| | | lactide | | | | | | |
| 6 | Al(salan) | rac- | BnOH | 8497 | 8440 | 1.19 | 95 | 2.21 |
| | | lactide | | | | | | |
| 7 | Al(salen) | rac- | MeOH | 8639 | 8501 | 1.22 | 92 | 2.40 |
| | | lactide | | | | | | |
| 8 | Al(salen) | rac- | BnOH | 8781 | 8688 | 1.22 | 94 | 2.40 |
| | | lactide | | | | | | |

^{c}D arm was calculated by Szymanski method (Szymanski, R. Macromolecules. 2002, 35, 8239-8242, incorporated herein by reference). D arm is the PDI of a single arm in a star or dendritic structure and gives a measure of how similar each arm is in length. The stereocomplexity of the linear PLA polymer chains for the above noted four star polymers is illustrated in Table 2.

TABLE 2
Tacticity as determined by decoupled 1H NMR.

| | Lactide | | |
|---|---|---|---|
| Catalyst | source | Tacticity | Tacticity Bias |
| tin(II)octanoate | rac-lactide | Atactic | 100% atacticity |
| Al(salan) | rac-lactide | Heterotactic | 85% heterotacticity |
| Al(salen) | rac-lactide | Isotactic stereoblock | 90% isotacticity |
| | | (D, L) | |
| tin(II)octanoate | L-lactide | Isotactic (L) | 100% isotacticity |

Tin(II)octanoate is shown below:

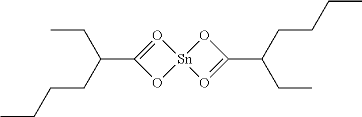 [SMILES: CCCCC(CC)C1[O][Sn]2([O]C(=[O]->2)C(CC)CCCC)<-[O]=1]

Various properties, such as degradation rates, can be controlled by the stereocomplexity of the PLA. For example, a random arrangement of D- and L-lactide monomers can produce a polymer that can degrade more quickly than a PDLLA polymer having a more defined arrangement of stereocenters.

In star polymers, a terminating group can be used to cap the PLA polymer. In some embodiments, an alkyl or aryl alcohol (such as methanol or benzyl alcohol), or substituted alkyl or aryl alcohol derivative, can be used as a terminating group. Varying the terminating group can result in changes to physical properties and degradation rates. Generally, benzyl alcohol, or other aryl groups, initiate the biodegradation later than alkyl alcohol groups or uncapped polymers. Similarly, alkyl alcohol capped polymers initiate the biodegradation later than uncapped polymers. This means that there is a delay before biodegradation begins, even though the end group typically has no effect on the rate of the degradation process.

Physical properties of the linear PLA polymer chains can be measured through dynamic scanning calorimetry (DSC) and thermogravimetric analysis (TGA). DSC is a thermoanalytical technique in which the difference in the amount of energy required to increase the temperature of a sample and reference is measured as a function of temperature. DSC can be used to study phase transitions, such as melting, glass transitions, or exothermic decompositions. TGA measures changes in weight in relation to change in temperature and can be used to determine degradation temperatures, absorbed moisture content of materials, the level of inorganic and organic components in materials, decomposition points of explosives, and solvent residues.

Simultaneous TGA/DSC can measure both heat flow and weight changes in a material as a function of temperature. Simultaneous measurement of these two material properties can be used to differentiate between endothermic and exothermic events which have no associated weight loss (e.g. melting and crystallization) and those which involve a weight loss (e.g. degradation).

The TGA data shown in Table 3 indicates that the star polymers with stereoregular polymer chains (i.e. isotactic (L), heterotactic and isotactic stereoblock (D, L)) show improved thermal stability compared to the star polymers with atactic chains. DSC results (Tₘ) indicate variable thermal properties, with the highest Tₘ values corresponding to the isotactic stereoblock polymerization of rac-lactide and L-lactide. The % tacticity bias for the star polymers described in Table 3 is shown in Table 2.

TABLE 3
TGA and DSC data for PLA-DPE star polymers.

| | | | | Term. | Onset | 50% | Final T | Tₘ | ΔT_{decomp} |
|---|---|---|---|---|---|---|---|---|---|
| # | Catalyst | Lactide | Tacticity | group | (° C.) | (° C.) | (° C.) | (° C.) | (° C.) |
| 1 | tin(II) | rac- | Atactic | MeOH | 232.2 | 255.1 | 320.5 | 53.26 | 88.3 |
| | octanoate | lactide | | | | | | | |
| 2 | tin(II) | rac- | Atactic | BnOH | 234.7 | 257.6 | 321.2 | 51.41 | 86.6 |
| | octanoate | lactide | | | | | | | |
| 3 | tin(II) | L- | Isotactic | MeOH | 267.3 | 302.2 | 350.0 | 129.47 | 82.7 |
| | octanoate | lactide | (L) | | | | | | |
| 4 | tin(II) | L- | Isotactic | BnOH | 276.4 | 304.5 | 354.3 | 121.01 | 77.9 |
| | octanoate | lactide | (L) | | | | | | |
| 5 | Al(salan) | rac- | Hetero- | MeOH | 275.8 | 305.3 | 351.2 | 88.32 | 75.4 |
| | | lactide | tactic | | | | | | |
| 6 | Al(salan) | rac- | Hetero- | BnOH | 278.7 | 309.1 | 351.2 | 82.12 | 72.5 |
| | | lactide | tactic | | | | | | |
| 7 | Al(salen) | rac- | Isotactic | MeOH | 274.8 | 306.2 | 375.5 | 127.97 | 100.6 |
| | | lactide | stereo- | | | | | | |
| | | | block | | | | | | |
| | | | (D, L) | | | | | | |
| 8 | Al(salen) | rac- | Isotactic | BnOH | 278.5 | 306.7 | 374.7 | 120.96 | 96.2 |
| | | lactide | stereo- | | | | | | |
| | | | block | | | | | | |
| | | | (D, L) | | | | | | |

The degradation rate of the DPE-PLA star polymers can vary based on crystallinity and/or tacticity bias. Degradation by transesterification of PLA can be measured using methanol in the presence of 1,5,6-triazabicyclo[4.4.0]dec-5-ene (TBD), at 100° C. Gas chromatography and/or mass spectrometry can be used to track the appearance of lactic acid, a product of the degradation process.

Increasing Tₘ and increasing isotactic bias of the star polymers has been determined to correlate with slower degradation kinetics. For example, it has been determined that the time required to reach 50% degradation is 50 times longer for isotactic (L) and isotactic stereoblock PLA polymers than for atactic PLA polymers.

Tacticity can be controlled by the reaction parameters used in the polymerization. For example, combining Al(salen) and Al(salan) in a molar ratio of 1:1 and using this catalyst mixture for the polymerization of rac-lactide results in polymers with intermediate TGA and DSC properties (˜270° C. onset and broader Tm distribution ˜100° C. average). Star polymers made with such PLA polymers have biodegradation rates that are lower than for the heterotactic polymers, but higher than for the isotactic polymers.

The introduction of stereocontrol has an effect on the thermal stability of the polymers. Atactic PLA stars exhibit the lowest thermal stability of the samples at the onset of intense thermal decomposition (˜230° C.), 50% sample decomposition (˜255 ° C.) and maximum decomposition temperature (˜320° C.). Onset temperatures for polymers with a specific tacticity bias can show an enhancement in thermal stability of 40° C. regardless of the relative stereochemistry of the polymer chain or monomer used. The presence of unique tetrads (RRRR/SSSS in isotactic or RRSS in heterotactic) can have reduced effect on either the onset or 50% decomposition temperatures. Differences can be observed, however, in the Tₘₐₓ values. Heterotactic and isotactic-(L) polymer stars can exhibit a stabilization of ˜30° C. relative to the Tₘₐₓ of the corresponding atactic polymer star. Isotactic-(D/L) polymer stars, prepared from the relatively inexpensive rac-lactide, can show a >50° C. increase in maximum thermal stability.

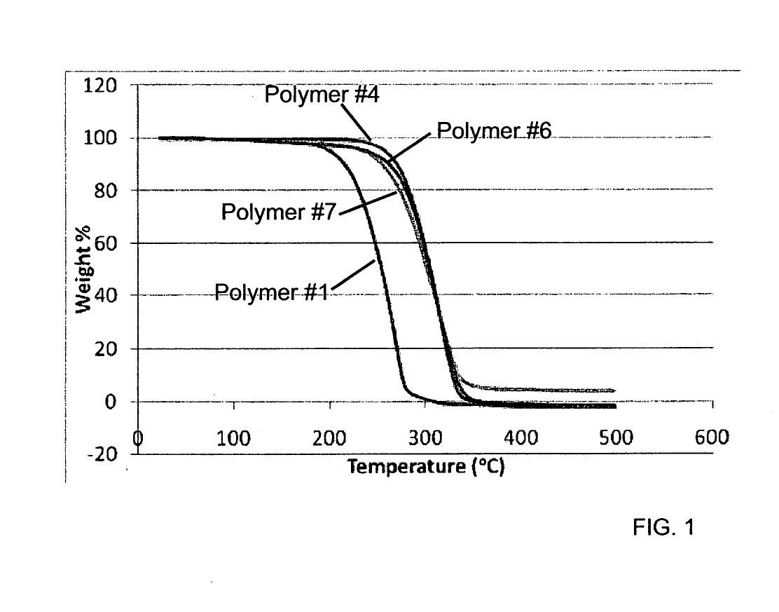

These two effects can manifest in differences in the temperature window over which these polymer stars decompose, with the ordered heterotactic and isotactic-(L) stars exhibiting more narrow decomposition profiles compared to isotactic-(D/L) poly(lactic acid) stars. As an example, an overlay of the TGA traces for four stars of various tacticities is shown in FIG. 1. As can be seen in FIG. 1, the extended decomposition window arises from a small portion (<5%) of high thermal stability and the majority of the isotactic-(D/L) decomposition occurs over a wider window than heterotactic and isotactic-(L) PLA stars. The effect of molecular weight on the decomposition temperatures appears minor, showing small differences in the onset temperatures.

TABLE 4
DSC thermal transitions observed for PLA-DPE star polymers.

| | | | | Term. | | | | |
|---|---|---|---|---|---|---|---|---|
| # | Catalyst | Lactide | Tacticity | group | T_{g} (° C.) | Tₘ (° C.) | ΔHₘ (J/G) | T_{c} (° C.) |
| 1 | tin(II) | rac- | Atactic | MeOH | 39.90 | — | — | — |
| | octanoate | lactide | | | | | | |
| 2 | tin(II) | rac- | Atactic | BnOH | 37.29 | — | — | — |
| | octanoate | lactide | | | | | | |
| 3 | tin(II) | L- | Isotactic | MeOH | 48.24 | 122.91, | 39.2 | 96.94 |
| | octanoate | lactide | (L) | | | 137.39 | | |
| 4 | tin(II) | L- | Isotactic | BnOH | 47.67 | 131.96, | 30.8 | — |
| | octanoate | lactide | (L) | | | 142.93 | | |
| 5 | Al(salan) | rac- | Hetero- | MeOH | 41.52 | — | — | — |
| | | lactide | tactic | | | | | |
| 6 | Al(salan) | rac- | Hetero- | BnOH | 41.45 | — | — | — |
| | | lactide | tactic | | | | | |
| 7 | Al(salen) | rac- | Isotactic | MeOH | 43.72 | 114.54, | 24.8 | 84.19 |
| | | lactide | stereo- | | | 134.41 | | |
| | | | block | | | | | |
| | | | (D, L) | | | | | |
| 8 | Al(salen) | rac- | Isotactic | BnOH | 43.26 | 117.18, | 28.7 | — |
| | | lactide | stereo- | | | 128.47 | | |
| | | | block | | | | | |
| | | | (D, L) | | | | | |

The DSC thermal transitions shown in Table 4 were measured employing: purge flow 50 mL/min N2, heating/cooling rate 5° C./min, Heat (160° C.)/Cool (0° C.)/Heat (160° C.) cycle. For reference, linear isotactic, heterotactic and atactic Tg values are 55-65° C., 40-45° C. and 53-54° C. respectively (see, Henton, D. E.; Gruber, P.; Lunt, J.; Randall, J. Polylactic Acid Technology. in Natural Fibres, Biopolymers and Biocomposites. Taylor and Francis Group, New York, 2005; and Becker, J. M.; Pounder, R. J.; Dove, A. P. Macromol. Rapid Commun. 2010, 31, ASAP. DOI: 10.1002/marc.201000088).

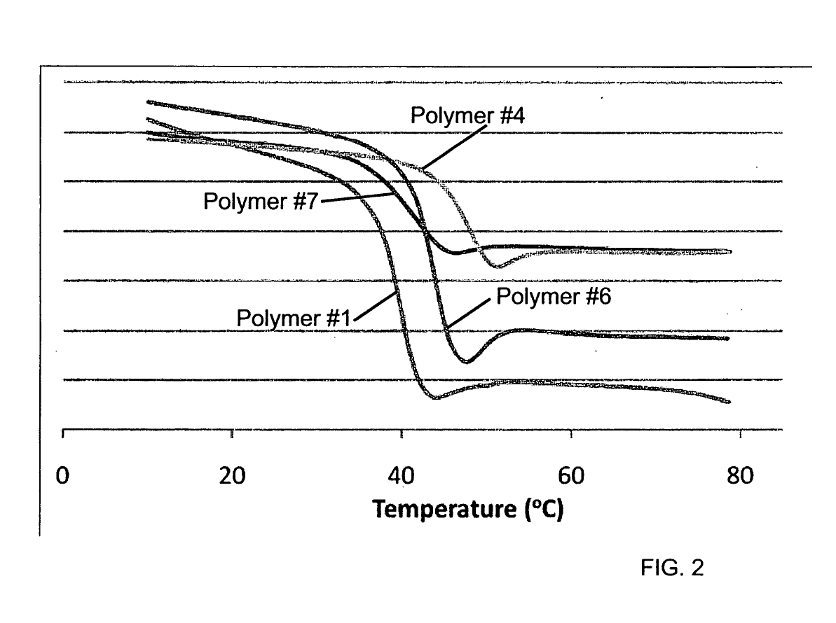

Across the samples discussed above, the small molecular weight differences observed impart little change to T_{g} values, with surprising consistency observed for heterotactic and isotactic samples. Atactic, heterotactic and isotactic polymer stars can exhibit glass transition temperatures, with clear differences observed for samples of different tacticities. Atactic PLA stars exhibit lower T_{g}, while purely isotactic stars derived from L-lactide possess higher T_{g}. Interestingly, heterotactic and isotactic-(rac) stars possess a T_{g} between these two values, suggesting that the stereoerrors in the polymers produced from rac lactide lower the temperature of the observed glass transitions. Variations in T_{g} for a subsection of PLA polymer stars are shown in FIG. 2.

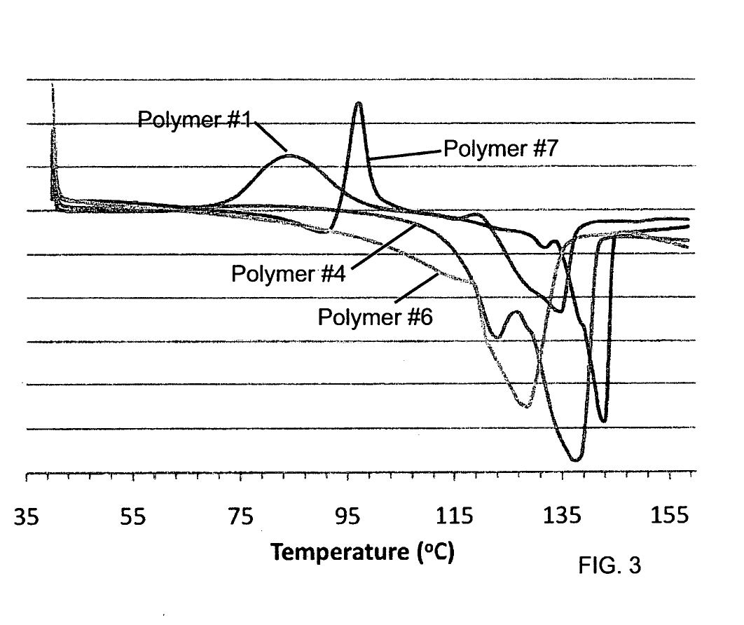

Melting temperatures, in agreement with studies on linear PLA have been observed only for isotactic PLA stars. The lack of true melting signals for atactic PLA is in accord with its amorphous nature, while the lack of heterotactic PLA melting signals remains an unexplained artifact of its microstructure. The presence of two melting signals in isotactic samples is indicative of star-shaped PLAs, suggesting the polymers are semi-crystalline. Differences in crystallite size and varying degrees of crystallinity within the polymer star sample may create the two transitions. As was the case for T_{g} transitions, isotactic-(rac) Tₘ transitions are lower than for isotactic-(L) stars, suggesting that the Tₘ can be tuned by slight variations of the monomer composition or stereoerrors incorporated into the framework. The impact of these differences may be mitigated by differences observed between samples of varying molecular weights. Still, when comparing sample #8 (8688 Da) and sample #3 (8691 Da) the effect of utilizing rac-LA is clear. Crystallization temperatures were measured for select samples. Broad, lowered crystallization temperatures suggest that the materials can form highly crystalline segments even at lower temperatures, supporting the possible presence of highly ordered stereocomplex segments. Representative DSC plots are shown in FIG. 3.

The percent crystallinity was also calculated for isotactic samples from the theoretical ΔH_{fus} for idealized 100% crystalline PLA of 93.1 J/g. These samples were compared by examining their preferred crystalline form, the induced crystallinity observed was not subtracted from the T_{c} in samples #7 and #4 in order to more accurately represent trends in polymer star crystallinity. As expected, samples generated from pure L-lactide (3-sample average of 37%) can possess higher % crystallinity than their rac-lactide counterparts (28%). The presence of stereoerrors may lower the ability of the polymer to form crystalline regions.

The semi-crystalline natures of star-shaped PLAs were further investigated by powder X-ray diffraction. Samples were prepared as solid pellets on glass substrates and the Scherrer equation (see Patterson, A. L. Physical Review. 1939, 56, 978-982) was utilized to calculate crystallite size. These values are reported in Table 5.

TABLE 5
p-XRD data for PLA-DPE star polymers (Scherrer parameters: K = 0.9,
λ = 1.542).

| | | | | | Angle | Crystallite | d-spacing |
|---|---|---|---|---|---|---|---|
| # | Catalyst | Lactide | Tacticity | Term. group | (°) | size (nm) | (Å) |
| 1 | tin(II) | rac- | Atactic | MeOH | — | — | — |
| | octanoate | lactide | | | | | |
| 2 | tin(II) | rac- | Atactic | BnOH | — | — | — |
| | octanoate | lactide | | | | | |
| 3 | tin(II) | L- | Isotactic | MeOH | 16.830 | 188 | 5.266 |
| | octanoate | lactide | (L) | | | | |
| 4 | tin(II) | L- | Isotactic | BnOH | 16.941 | 170 | 5.236 |
| | octanoate | lactide | (L) | | | | |
| 5 | Al(salan) | rac- | Hetero- | MeOH | — | — | — |
| | | lactide | tactic | | | | |
| 6 | Al(salan) | rac- | Hetero- | BnOH | — | — | — |
| | | lactide | tactic | | | | |
| 7 | Al(salen) | rac- | Isotactic | MeOH | 16.909 | 178 | 5.242 |
| | | lactide | stereo- | | | | |
| | | | block | | | | |
| | | | (D, L) | | | | |
| 8 | Al(salen) | rac- | Isotactic | BnOH | 16.926 | 160 | 5.239 |
| | | lactide | stereo- | | | | |
| | | | block | | | | |
| | | | (D, L) | | | | |

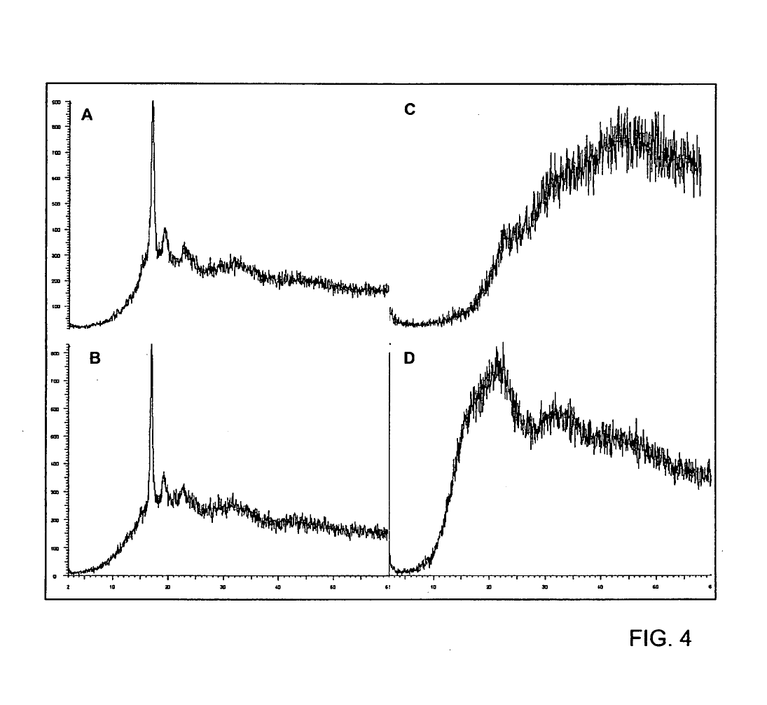

The angle of diffraction representing the crystalline regions of isotactic samples #3, #4, #7 and #8 is consistent, adding further evidence to the strong isotactic bias imposed by catalyst ^{tBu}[salen]AlMe (1). Crystallite size is relatively consistent between isotactic samples. FIG. 4, a collection of X-ray powder diffraction spectra, shows this trend more clearly. Spectra A and B, representing entries for samples #4 and #7, respectively, show sharp diffraction peaks and small lower order diffraction peaks from crystalline regions superimposed over a broad sample baseline indicative of amorphous character. Finally, atactic and heterotactic PLA are shown in spectra C and D (samples #5 and #1, respectively) and are completely amorphous with no quantifiable reflections. No significant differences are observed in the X-ray powder patterns of samples possessing the same tacticity bias.

Polymer Degradation. Pellets of atactic, heterotactic, isotactic-(rac) and isotactic-(L) PLA stars were prepared in a manual press and exposed to a 0.05% (w/v) solution of TBD (1,5,7-triazabicyclo[4.4.0]dec-5-ene) in methanol. This organic base has been shown to be highly successful in promoting the degradation of PLA materials into lactic acid via transesterification (see Joung, Y. K.; Lee, J. S.; Park, K. D.; Lee, S.-J. Macromol. Res. 2008, 16, 66-69). The times required for complete degradation and solvation of six pellets of each tacticity were recorded and degradation confirmed by both 1H NMR spectroscopy and GPC analysis. Polymer stars with an atactic bias degraded the fastest, in an average of 20.5 minutes. Heterotactic samples also degraded relatively quickly, with average lifetimes of 23.0 minutes. The degradation of these heterotactic PLA samples agrees with reports on degradation of linear PLA homopolymers (see Althoff, B.; Trolls\dot{a}s, M.; Claesson, H.; Hedrick, J. L. Macromol. Chem. Phys. 1999, 200, 1333-1339). Little variation was observed between samples with slightly different molecular weights.

Surprisingly, differences were observed when examining the degradation of isotactic rac- and L-lactide derived star polymers. Over a longer timeframe, sample degradation times correlated to small differences in molecular weight. However, greater differences were observed that correlated to the tacticity bias of the samples. In isotactic samples (ranging in Mₙ from 8.4 to 8.9 kDa) rac-PLA star degradation times varied from 51 to 66 minutes. These degradation rates appear to be 2-3 times faster for atactic samples versus isotactic samples derived from rac-LA. Further stability towards degradation was found in moving to isotactic-L PLA star polymers, where degradation times ranged from 167 to 184 minutes. The stereopure form can persist for 3 times longer than that of isotactic samples derived from rac-LA, illustrating the effect of stereoerrors on the stability of the samples.

### EXAMPLES

Materials. HPLC-grade acetone, acetonitrile, dichloromethane, ethanol, methanol and toluene were purchased from Fisher Scientific while deuterated solvents were purchased from Cambridge Isotopes. Acetonitrile was dried by stirring the solvent over calcium hydride for 48 hours, distilling under a dinitrogen atmosphere and thoroughly degassing the anhydrous solvent. Anhydrous toluene was obtained by passing the solvent through an Innovative Technologies solvent purification system consisting of columns of alumina and a copper catalyst. Anhydrous solvents were tested with addition of a toluene solution of sodium benzophenone ketyl prior to use. Deuterated solvents were dried in analogous procedures, then trap-to-trap distilled and freeze-pump-thaw degassed three times. Chemicals for catalyst synthesis, including trimethyl aluminum (2.0 M solution in hexanes), 2,4-dichiorophenol, N,N′-dibenzylethylenediamine, paraformaldehyde, 3,5-ditertbutyl-2-hydroxybenzaldehyde, 1,2-diaminoethane, and tin(II)ethylhexanoate were purchased from Aldrich Chemical Co. and used as received. Dipentaerythritol was purchased from Aldrich Chemical Co. and purified by recrystallization from methanol and dried in a desiccator for 48 h prior to use. The monomers rac- and L-lactide were purchased from PURAC Biomaterials and purified by three successive vacuum sublimations of the material prior to use. 1,5,7-triazabicyclo[4,4,0]dec-5-ene was purchased from Aldrich Chemical Co. and used as received. The aluminum catalysts ^{tBu}[salen]AlMe (1), where ^{tBu}[salen] is N,N′-ethylenebis(3,5-di(tert-butyl)salicylimine), and ^{Cl}[salan]AlMe (2), where ^{Cl}[salan] is N,N′-ethylenebis(benzyl)(bis(3,5-dichlorosalicylamine), were synthesized by following procedures previously reported. See, for example, Hormnirun, P.; Marshall, E. L.; Gibson, V. C.; White, A. J. P.; Williams, D. J. J. Am. Chem. Soc. 2004, 126, 2688-2689; and Hormnirun, P.; Marshall, E. L.; Gibson, V. C.; Pugh, R. I.; White, A. J. P. Proc. Nat. Acad. Sci. 2006, 103, 15343-15348, which are incorporated herein by reference.

General Considerations. All experiments involving moisture and air sensitive compounds and catalysts were performed under a nitrogen atmosphere using an MBraun LABmaster sp glovebox system equipped with a −33° C. freezer and [H₂O] and [O₂] analyzers. Gel permeation chromatography (GPC) was carried out in THF (flow rate: 1 mL min⁻¹) at 50° C. with a Polymer Labs PL-GPC 50 Plus integrated GPC system using three 300×7.5 mm Resipore columns. Polystyrene standards were used for calibration and corrected for PLA. 1H-NMR and 2-D spectra were recorded with a Bruker Avance Spectrometer (300 MHz) in CDCl₃, CD₃OH or C₆D₆. Elemental analyses were conducted by Guelph Analytical Laboratories. Thermogravimetric analysis was performed on a TA instruments TGA Q500 under an inert nitrogen atmosphere with a flow rate of 60 mL min⁻¹ and a heating rate of 10° C. min⁻¹. Differential scanning calorimetry was performed on a TA instruments DSC Q100 using a heating rate of 10° C. min⁻¹. Powder X-ray diffraction was performed on a Bruker AXS D8 Advance diffractometer equipped with a graphite monochromator, variable divergence and antiscatter slits, and a scintillation detector. Cu Kα radiation (λ=1.542 Å) was used and data collection was carried out in air, at room temperature, using a scan range of 2-60°. Solid samples were pressed as thin pellets and run on a nondiffracting silicon substrate.

Polymerization Experiments. All polymerization reactions were performed in sealed ampoules under an inert atmosphere, at 120° C., with a molar ratio of monomer : catalyst:alcohol functionality of 60:1.2:1. Catalysts employed included ^{tBu}[salen]AlMe (1) and ^{Cl}[salan]AlMe (2) and Sn(Oct)₂ (i.e. tin(II)octanoate) (3). Monomers employed included rac-lactide and L-lactide while the initiator molecule was either benzyl alcohol or dipentaerythritol. The reaction proceeded for the allotted period of time required to reach 90% conversion and was then quenched with a 10:1 v/v solution of either CH₂Cl₂/MeOH or CH₂Cl₂/PhCH₂OH for 30 min at room temperature to form hydroxy-terminated polymer chains. The resulting mixture was precipitated from cold methanol, collected via filtration and dried in vacuo prior to analysis.

For example, rac-lactide (0.500 g, 3.52 mmol), dipentaerythritol (0.0148 g, 0.0587 mmol) and catalyst ^{tBu}[salen]AlMe (1), (0.0384 g, 0.0704 mmol) were added to an ampoule equipped with a magnetic stirring bar in the glovebox. The ampoule was sealed and placed in a preheated oil bath at 120° C. for six hours. The ampoule was removed from the oil bath, cooled to room temperature, opened to the atmosphere and quenched with 10 mL of a 10:1 v/v solution of CH₂Cl₂ and methanol. The solution was stirred for 30 minutes and then added dropwise to 100 mL of cold methanol to precipitate the polymer. The resultant white polymer was collected via filtration and dried in vacuo for 12 hours. Monomer conversion was determined gravimetrically to be 92% (0.474 g).

Degradation experiments. Poly(lactic acid) star polymer samples (200.0 mg) were pressed into thin pellets and suspended in 5.0 mL of a 0.05% weight/volume solution of 1,5,7-triazabicyclo[4.4.0]dec-5-ene (TBD) in methanol in a 25 mL scintillation vial. The solutions were agitated at 23° C. until degradation was complete and the time to complete degradation recorded. Degradation of the materials was confirmed by GPC and NMR spectroscopy. Experiments were performed in quadruplicate to ensure the integrity of the results.

### Example 1

### Synthesis of Aluminum-Salan Catalyst ^{Cl}[O,N,N,O]AlMe

Aluminum-salan catalyst ^{Cl}[O,N,N,O]AlMe was prepared as described in Hormnirun, P; Marshall, E; Gibson, V; White, A; Williams, J. J. Am. Chem. Soc. 2004, 126, 2688.

To a stirred mixture of 2,4 dichlorophenol (25.0958 g, 154 mmol) and N,N′-dibenzylethylenediamine (18.16 mL, 77 mmol) in ethanol (200 mL) was added paraformaldehyde (4.6448 g, 154 mmol) at reflux. The solution was allowed to stir overnight at 90° C. Upon completion, the white precipitate was vacuum filtered and collected to produce N,N′-bis{(3,5-dichloro-2-hydroxyphenyl)methylene]-1,2-diaminoethane, in a yield of 76%. ¹H NMR (CDCl₃): δ 11.46 (2H, s, OH), 7.36-7.25 (8H, m, Ar), 7.17-7.11 (4H, m, Ar), 6.82 (2H, d, Ar), 3.64 (4H, s, NCH₂C₆H₄OH).

To a stirred solution of N,N′-bis{(3,5-dichloro-2-hydroxyphenyl)methylene]-1,2-diaminoethane (1.3992 g, 2.37 mmol), in toluene (20 mL) was added AlMe₃ (1.2 mL, 2.40 mmol). The reaction mixture was allowed to stir at 110° C. overnight. The solvent was evaporated to dryness resulting in a white solid of 44% yield. ¹H NMR (C₆D₆): δ 7.37 (2H, d, Ar), 7.06-7.02 (6H, m, Ar), 6.86-6.83 (4H, m, Ar), 6.56 (2H, d, Ar), 5.1-2.9 (4H, m, NCH₂C₆H₄OH), 3.24 (4H, s, NCH₂C₆H₅), 2.5-1.5 (4H, m, N(CH₂CH₂)N), −0.27 (3H, s, AlCH₃).

### Example 2

### Aluminum-Salen Catalyst ^{t-Bu}[O,N,N,O]AlMe

Aluminum-salen catalyst ^{t-Bu}[O,N,N,O]AlMe was prepared as described in Hormnirun, P; Marshall, E; Gibson, V; Pugh, R; White, A. PNAS. 2006, 103, 15343.

To a stirred solution of 3,5-di-tert-butyl-2-hydroxybenzaldehyde (2.5780 g, 11 mmol) in ethanol (25 mL) was dropwise added 1,3-propanediamine (0.4275 g, 6 mmol). The reaction mixture was allowed to stir at 70° C. overnight. Upon completion, the yellow precipitate was vacuum filtered and collected to produce N,N′-bis(3,5-di-tert-butylsalicylidene)-1,3-propanediamine, in a yield of 66%. ¹H NMR (CDCl₃): δ 13.40 (2H, s, OH), 8.37 (2H, s, NCH), 7.35-7.23 (4H, m, Ar), 6.98-6.84 (4H, m, Ar), 3.72 (4H, t, N(CH₂CH₂CH₂)N), 2.12 (2H, N(CH₂CH₂CH₂)N).

To a stirred solution of N,N′-bis(3,5-di-tert-butylsalicylidene)-1,3-propanediamine (0.998 g, 1.97 mmol) in toluene (10 mL) was added AlMe₃ (1.0 mL, 2.0 mmol). The reaction mixture was allowed to stir at 110° C. overnight. The solution was evaporated to dryness resulting in a yellow-green solid of 55% yield. ¹H NMR (CDCl₃): δ 8.19 (2H, s, NCH), 7.38-6.64 (8H, m, Ar), 4.09-2.05 (6H, m, N(CH₂CH₂CH₂)N), −0.83 (3H, s, AlCH₃).

### Example 3

### Synthesis of Star Polymers Using Aluminum Catalysts

All polymerization reactions to form star polymers were performed under an inert atmosphere environment using a solvent free synthesis method. The typical monomer:initiator:catalyst molar ratios are 100:1.67:1. Generally, 3,6-dimethyl-1,4-dioxane-2,5-dione (D,L-lactide, 0.500 g, 3.52 mmol), dipentaerythritol (0.0148 g, 0.058 mmol) and aluminum catalyst (0.0192 g, 0.0352 mmol) were added to an ampoule equipped with a magnetic stirring bar. The sealed ampoule was then heated at 120° C. for the allotted time period before the reaction was quenched with a solution of CH₂Cl₂/MeOH or CH₂Cl₂/BnOH (20 mL/1 mL). Generally, the sealed ampoule is heated for approximately 6 hours. The dissolved mixture was allowed to stir for 30 minutes to promote full termination. The resultant polymer was then precipitated from cold methanol with stirring and dried in vacuo in preparation for analysis.

Polymerization reactions were undertaken as described above using catalysts described in Examples 1 and 2, resulting in polymers described in Table 1, Table 2 and Table 3.

### Example 4

### Synthesis of Star Polymers Using Mixtures of Catalysts

A polymerization reaction, as described in Example 2, was performed using a mixture of Al(salen) and Al(salan) catalysts in a 1:1 molar ration, while maintaining the same total mol of Al. Due to overlap in hetero and iso peaks, no accurate tacticity bias from NMR could be determined. Multi-peak DSC showed broadened phase changes, but showed two peaks—one for heterotactic and the other for isotactic linkages. The TGA had a lower onset than the isotactic star polymer, and a higher onset Tₘ (270° C.) than the heterotactic star polymer (254° C.).

Similarly, a polymerization reaction was performed using a mixture of Al(salen) and tin(II)octanoate in a 1:1 molar ration, while maintaining the same total mol of Lewis acid. The resulting star polymer was determined to have 20% isotacticity bias using standard NMR techniques. Multi-peak DSC showed broadened phase changes—reflecting high atactic content. TGA showed broader peaks similar to atactic peaks.

Similarly, a polymerization reaction was performed using a mixture of Al(salen) and tin(II)octanoate in a 5:1 molar ration, while maintaining the same total mol of Lewis acid. Multi-peak DSC showed a mixture of isotactic/atactic polymer, although the lower atactic catalyst content resulted in higher isotacticity bias (62% by NMR). The DSC peaks were narrower than the polymerization performed with 1:1 Al(salen):tin(II)octanoate. The TGA was higher (Tₘ onset of 266° C.).

### Example 5

### Decomposition of poly(lactic Acid)-Based Star Polymers

Samples (5 mg/mL) of dried polylactic acid)-based star polymer were dissolved in a mixture of 80:20 acetone:methanol, volume:volume. To this is added 1 molar equivalent of 1,5,7-triazabicyclo[4,4,0]dec-5-ene with respect to the star polymer. The samples were enclosed in a sealed ampule and heated to 100° C.

In order to obtain a time-course for decomposition, aliquots of the decomposition reaction were removed at appropriate intervals, usually every 12 hour. Any remaining star polymer was precipitated in cold, acidified methanol, collected by filtration and dried in vacuo. The chemical stability of the star polymer was measured gravimetrically by weighing the dried precipitated star polymer. The supernatant liquid was analyzed by NMR to quantify, using ferrocene as an internal standard, the formation of lactic acid, i.e. the decomposition product of the PLA-based star polymer.

For example, isotactic stereoblock PLA-base star polymer was dissolved in a mixture of 80:20 acetone:methanol at a concentration of 5 mg/mL. To this mixture was added 1 mol equivalent of TBD and the reaction vessel was sealed. The contents were heated to 100° C. and aliquots removed for analysis at 12, 24, 36 and 48 hours. The star polymer material was determined to be degraded to 42% of its original weight after 48 hours, as determined gravimetrically.

Isotactic stereoblock PLA-based star polymers show high tacticity bias and high Tₘs (see Table 3). When atactic PLA-based star polymers are used under the same degradation reaction conditions, the star polymer degrades completely within 12 hours with no remaining polymer being observed.

### Example 6

### Measurment of Tacticity Bias

Tacticity bias for a particular stereosequence distribution of PLA-based polymer stars is measured by 1H NMR spectroscopy by selectively decoupling the methyl protons from the methine protons in the PLA chains. Depending upon the magnetic field strength used, the NMR chemical shifts of the 1H nuclei in PLA are influenced by the stereoconfiguration of 1-3 adjacent stereogenic centres on either side. If the polymerization is atactic, the stereosequence distribution is expected to match the predicted statistical distribution. Deviation from this random order can be measured by integrating the relevant peaks and a tacticity bias for a particular stereosequence can be obtained.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

1. A star polymer comprising:
a poly-functional core linked to at least two arms, the at least two arms comprising a polymerized monomer, the monomer having at least one stereocentre and being a stereoblock co-polymer comprising heterotactic and isotaclic stereoblocks;
wherein the star polymer has a heterotacticity bias between about 1% and 99% and an isotacticity bias between about 1% and 99%.

2. The star polymer according to claim 1, wherein the polymerized monomer further comprises atactic stereoblocks.

3. The star polymer according to claim 1, wherein the poly-functional core is linked to 6 arms.

4. A method of synthesizing a star polymer, the method comprising the steps of:
reacting a lactone-based monomer and a poly-functional initiator in the presence of at least one catalyst to produce the star polymer, wherein:
the reaction is a low solvent reaction,
the monomer does not comprise —NH— or —OH functional groups or double bonds or triple bonds,
the monomer has at least one stereocentre, and either:
the synthesized star polymer comprises at least two arms comprising a polymerized monomer, the polymerized monomer being a stereoblock copolymer comprising heterotactic and isotactic stereoblocks, and the synthesized star polymer has a heterotacticity bias between about 1% and 99% and an isotacticity bias between about 1% and 99%; or
ii) the synthesized star polymer has:
(a) a heterotacticity bias between 1% and 90%; or
(b) a heterotacticity bias between 1% and 90% and an isotacticity bias between 1% and 99%.

5. The method according to claim 4, wherein:
the synthesized star polymer comprises at least two arms comprising a polymerized monomer, the polymerized monomer being a stereoblock co-polymer comprising heterotactic and isotactic stereoblocks, and
the synthesized star polymer has a heterotacticity bias between 1% and 90% and has an isotacticity bias between 1% and 99%.

6. The method according to claim 4, wherein:
the synthesized star polymer comprises at least two arms comprising a polymerized monomer, the polymerized monomer being a stereoblock co-polymer comprising heterotactic and isotactic stereoblocks, and the synthesized star polymer has a heterotacticity bias between about 1% and 99% and an isotacticity bias between about 1% and 99%; and
the lactone-based monomer is lactide.

7. The method according to claim 4, wherein:
the synthesized star polymer comprises at least two arms comprising a polymerized monomer, the polymerized monomer being a stereoblock co-polymer comprising heterotactic and isotactic stereoblocks, and the synthesized star polymer has a heterotacticity bias between about 1% and 99% and an isotacticity bias between about 1% and 99%; and
the poly-functional initiator is dipentaerythritol.

8. The method according to claim 4, wherein the synthesized star polymer has:
(a) a heterotacticity bias between 1% and 90%; or
(b) a heterotacticity bias between 1% and 90% and an isotacticity bias between 1% and 99%.

9. The method according to claim 8, wherein the lactone-based monomer is lactide.

10. The method according to claim 8, wherein the poly-functional initiator is dipentaerythritol.

11. A method of synthesizing a star polymer, the method comprising the steps of:
reacting a lactone-based monomer and a poly-functional initiator in the presence of at least one catalyst to produce the star polymer, wherein:
the reaction is a low solvent reaction;
the monomer does not comprise —NH— or —OH functional groups or double bonds or triple bonds; and further wherein either:
i) the at least one catalyst is a Lewis acid-based catalyst comprising Al, Zn, Mg, Ca, Fe, Ga, or In, the catalyst has an alkyl functionality or has an alkyl functionality created in situ, and the catalyst is thermally stable at reaction conditions; or
ii) the at least one catalyst is selected from the group consisting of 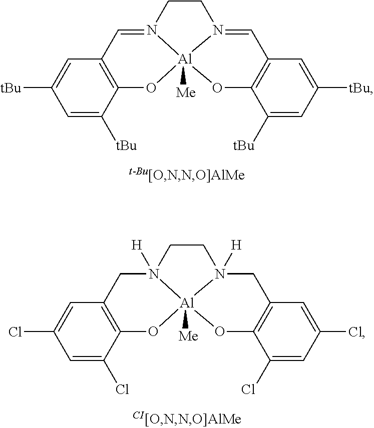
tin(II)octanoate, and any combination thereof.

12. The method according to claim 11, wherein:
the at least one catalyst is a Lewis acid-based catalyst comprising Al, Zn, Mg, Ca, Fe, Ga, or In;
the catalyst has an alkyl functionality or has an alkyl functionality created in situ;
the catalyst is thermally stable at reaction conditions; and
the monomer has at least one stereocentre and the synthesized star polymer has:
(a) a heterotacticity bias between about 1% and 100%;
(b) an isotacticity bias between about 1% and 100%; or
(c) a heterotacticity bias between about 1% and 99% and an isotacticity bias between about 1% and 99%.

13. The method according to claim 12, wherein the synthesized star polymer comprises at least two arms comprising a polymerized monomer, the polymerized monomer being a stereoblock co-polymer comprising heterotactic and isotactic stereoblocks, and the star polymer has a heterotacticity bias between about 1% and 99% and an isotacticity bias between about 1% and 99%.

14. The method according to claim 12, wherein the synthesized star polymer has:
(a) a heterotacticity bias between 1% and 90%; or
(b) a heterotacticity bias between 1% and 90% and an isotacticity bias between 1% and 99%.

15. The method according to claim 13, wherein the synthesized star polymer has a heterotacticity bias between 1% and 90% and has an isotacticity bias between 1% and 99%.

16. The method according to claim 11, wherein the at least one catalyst is selected from the group consisting of 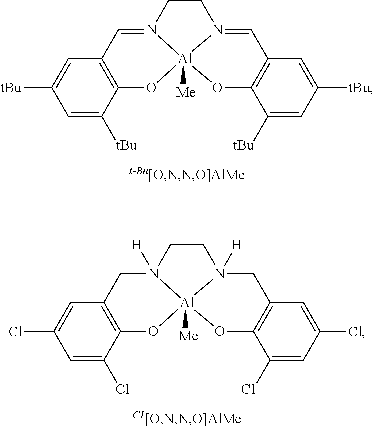
tin(II)octanoate, and any combination thereof.

17. The method according to claim 16, wherein the monomer has at least one stereocentre and the synthesized star polymer has:
(a) a heterotacticity bias between about 1% and 100%;
(b) an isotacticity bias between about 1% and 100%; or
(c) a heterotacticity bias between about 1% and 99% and an isotacticity bias between about 1% and 99%.

18. The method according to claim 17, wherein the synthesized star polymer comprises at least two arms comprising a polymerized monomer, the polymerized monomer being a stereoblock co-polymer comprising heterotactic and isotactic stereoblocks, and the star polymer has a heterotacticity bias between about 1% and 99% and an isotacticity bias between about 1% and 99%.

19. The method according to claim 17, wherein the synthesized star polymer has:
(a) a heterotacticity bias between 1% and 90%; or
(b) a heterotacticity bias between 1% and 90% and an isotacticity bias between 1% and 99%.

20. The method according to claim 18, wherein the synthesized star polymer has a heterotacticity bias between 1% and 90% and has an isotacticity bias between 1% and 99%.
